(19) United States
(12) Patent Application Publication
(10) Pub. No.: US 2021/0343462 A1
(43) Pub. Date: Nov. 4, 2021

(54) ELECTROMAGNETIC ACTUATOR

(71) Applicant: DENSO CORPORATION, Kariya-city (JP)

(72) Inventor: Hitoshi AMANO, Kariya-city (JP)

(21) Appl. No.: 17/241,435

(22) Filed: Apr. 27, 2021

(30) Foreign Application Priority Data
Apr. 30, 2020 (JP) 2020-080348

(51) Int. Cl. H01F 7/08; H01F 7/128; H01F 7/16

(52) U.S. Cl. CPC H01F 7/081; H01F 2007/086; H01F 7/16; H01F 7/128

(57) ABSTRACT

An electromagnetic actuator includes a stator and a movable element. The movable element is attracted from a stroke start position to a stroke end position in a predetermined stroke in an axial direction by magnetic force generated between the stator and the movable element when a coil is energized. The stator includes a first stator located adjacent to the movable element at the stroke start position and a second stator located closer to the movable element at the stroke end position than at the stroke start position. The movable element includes a tapered portion that has a diameter becoming smaller toward the second stator and a protrusion that protrudes from an end surface of the movable element close to the second stator.

### CROSS REFERENCE TO RELATED APPLICATION

The present application claims the benefit of priority from Japanese Patent Application No. 2020-080348 filed on Apr. 30, 2020. The entire disclosure of the above application is incorporated herein by reference.

### TECHNICAL FIELD

The present disclosure relates to an electromagnetic actuator in which a movable element is attracted in an axial direction by magnetic force generated between a stator and the movable element.

### BACKGROUND

A known electromagnetic actuator includes two stators arranged in an axial direction between a coil and a movable element.

### SUMMARY

In one aspect of the present disclosure, an electromagnetic actuator includes a stator and a movable element. The movable element is attracted from a stroke start position to a stroke end position in a predetermined stroke in an axial direction by magnetic force generated between the stator and the movable element when a coil is energized. The stator includes a first stator located adjacent to the movable element at the stroke start position and a second stator located closer to the movable element at the stroke end position than at the stroke start position. The movable element includes a tapered portion that has a diameter becoming smaller toward the second stator and a protrusion that protrudes from an end surface of the movable element close to the second stator.

### BRIEF DESCRIPTION OF DRAWINGS

FIG. 1 is a sectional view of an electromagnetic actuator according to a first embodiment.

FIG. 2 is a sectional view of the electromagnetic actuator after a movable element is moved to a stroke end position.

FIG. 3 is an enlarged view showing an area III in FIG. 1.

FIG. 4 is an enlarged view showing an area IV in FIG. 2.

FIG. 5 is a graph showing an attractive force characteristic of the electromagnetic actuator.

FIG. 6 is a sectional view of a part of an electromagnetic actuator in a comparative example.

FIG. 7 is a sectional view of an electromagnetic actuator according to a second embodiment.

### DETAILED DESCRIPTION

An electromagnetic actuator may include two stators arranged in an axial direction between a coil and a movable element. For example, in an electromagnetic actuator, a first stator is located closer to a movable element at a stroke start position than at a stroke end position, while a second stator is located closer to the movable element at the stroke end position than at the stroke start position. The movable element includes a tapered portion which has a diameter becoming smaller as close to the second stator. While the movable element is moved toward the stroke end position, an area of the gap between the movable element and the first stator is changed because of the tapered portion, such that attractive force in a stroke process is equalized.

However, in the electromagnetic actuator described above, the tapered portion has a diameter becoming smaller toward the second stator. Because of this, when the movable element is located at the stroke start position, the gap between the movable element and the second stator becomes large because of the tapered portion. Therefore, the attractive force at an initial stage of a start is reduced, and it is difficult to secure a constant attractive force characteristic over an entire length of the stroke.

The present disclosure is provided with an electromagnetic actuator configured to restrict a reduction in attractive force at an initial stage of a start and to secure a constant attractive force characteristic over an entire length of a stroke.

According to an exemplar embodiment of the present disclosure, an electromagnetic actuator includes a stator and a movable element. The movable element is configured to be attracted from a stroke start position to a stroke end position in a predetermined stroke in an axial direction by magnetic force generated between the stator and the movable element when a coil is energized. The stator includes a first stator located adjacent to the movable element at the stroke start position and a second stator located closer to the movable element at the stroke end position than at the stroke start position. The movable element includes a tapered portion that has a diameter becoming smaller toward the second stator and a protrusion that protrudes from an end surface of the movable element close to the second stator.

In the electromagnetic actuator in the present disclosure, when the movable element is located at the stroke start position, a part of the tapered portion which has a minimum diameter is close to the second stator. However, as the protrusion protrudes from the tapered portion toward the second stator, a gap between the movable element and the second stator is small. Therefore, the attractive force at the initial stage of the start of the actuator can be restricted from being reduced, and the constant attractive force characteristic can be secured over the entire length of the stroke.

### First Embodiment

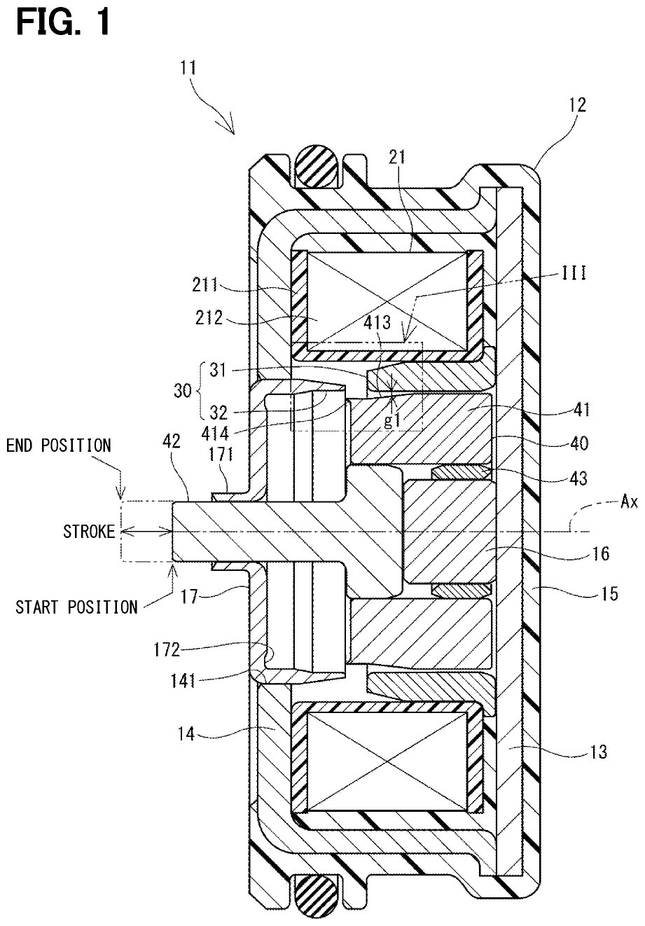

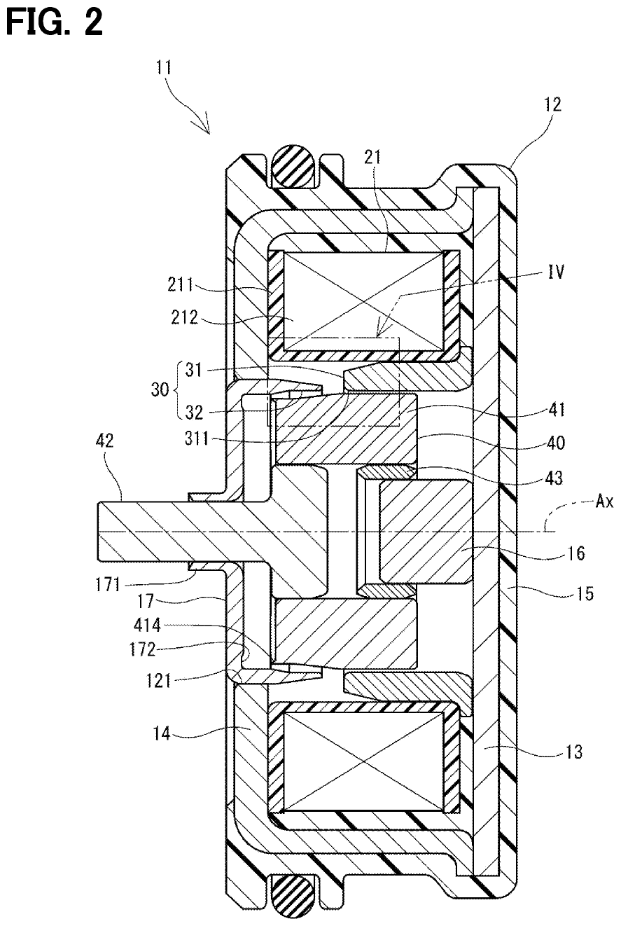

A first embodiment of the present disclosure will be described below with reference to drawings. An electromagnetic actuator 11 shown in FIGS. 1 and 2 is used as a linear solenoid for a valve timing adjustment mechanism of an internal combustion engine of a vehicle.

A housing 12 of the electromagnetic actuator 11 includes a base 13, a case 14, and an insulation film 15. The base 13 and the case 14 are made of magnetic materials. The insulation film 15 is made of resin and covers the base 13 and the case 14 entirely. A coil 21 is arranged inside the case 14 and is fixed to the housing 12 by a part of the insulation film 15. The coil 21 includes a bobbin 211 made of resin and a winding assembly 212. A whole of the coil 21 has an annular shape.

A stator 30 is arranged radially inside the coil 21, and a movable element 40 is arranged radially inside the stator 30. When the coil 21 is energized, the movable element 40 is attracted from a stroke start position to a stroke end position in a predetermined stroke in an axial direction of the electromagnetic actuator 11 by magnetic force generated between the stator 30 and the movable element 40. The axial direction described above corresponds to a direction in which an axis line Ax extends in FIG. 1.

The stator 30 includes a first stator 31 and a second stator 32. The first stator 31 is located adjacent to the movable element 40 at the stroke start position. The second stator 32 is located closer to the movable element 40 at the stroke end position than at the stroke start position. In other words, the first stator 31 and the second stator 32 are coaxially arranged such that the movable element 40 moves from a position facing the first stator 31 toward the second stator 32 when the coil 21 is energized. The first stator 31 is made of magnetic material and is formed in a cylindrical shape by a cold forging process. A base end of the first stator 31 is fixed to the base 13. The second stator 32 is formed in a cylindrical part of a cover member 17 made of magnetic material. The cover member 17 is fixed to the case 14 so as to cover a front opening 121 of the housing 12.

The movable element 40 includes a cylinder 41, a plunger 42, and a slider 43 which are combined with each other so as to be movable integrally. The cylinder 41 is made of magnetic material and is formed by a sintering process. The plunger 42 is an output shaft of the electromagnetic actuator 11. The cylinder 41 is provided radially inside the first stator 31 and the second stator 32 through a gap. A base of the plunger 42 is fixed to an inner peripheral surface of the cylinder 41 at one end portion. In this state, the plunger 42 is located on the axis line Ax of the electromagnetic actuator 11.

The slider 43 is made of low friction material and has a circular shape. The slider 43 is fixed to the inner peripheral surface of the cylinder 41 at the other end portion. A guide member 16 configured as a stopper of the plunger 42 is fixed to the base 13. The slider 43 is slidably fitted to the guide member 16. In addition, a boss portion 171 is formed on a center of the cover member 17, and the plunger 42 is inserted into the boss portion 171 slidably. That is, movement of the movable element 40 is guided by the guide member 16 and the cover member 17.

The first stator 31 and the second stator 32 are arranged along a direction in which the movable element 40 is moved and are arranged radially inside the coil 21. When the coil 21 is energized, the movable element 40 is attracted from the stroke start position to the stroke end position by magnetic force generated between the movable element 40 and the first stator 31 and by magnetic force generated between the movable element 40 and the second stator 32. FIG. 1 shows the movable element 40 at the stroke start position, and FIG. 2 shows the movable element 40 at the stroke end position.

The stroke end position is not limited to a position shown in FIG. 2. The stroke end position may be set closer to the cover member 17 than a position shown in FIG. 2, depending on an usage of the electromagnetic actuator 11. When energization to the coil 21 is stopped, the movable element 40 returns from the stroke end position to the stroke start position because of a spring arranged in a driven device such as the valve timing adjustment mechanism.

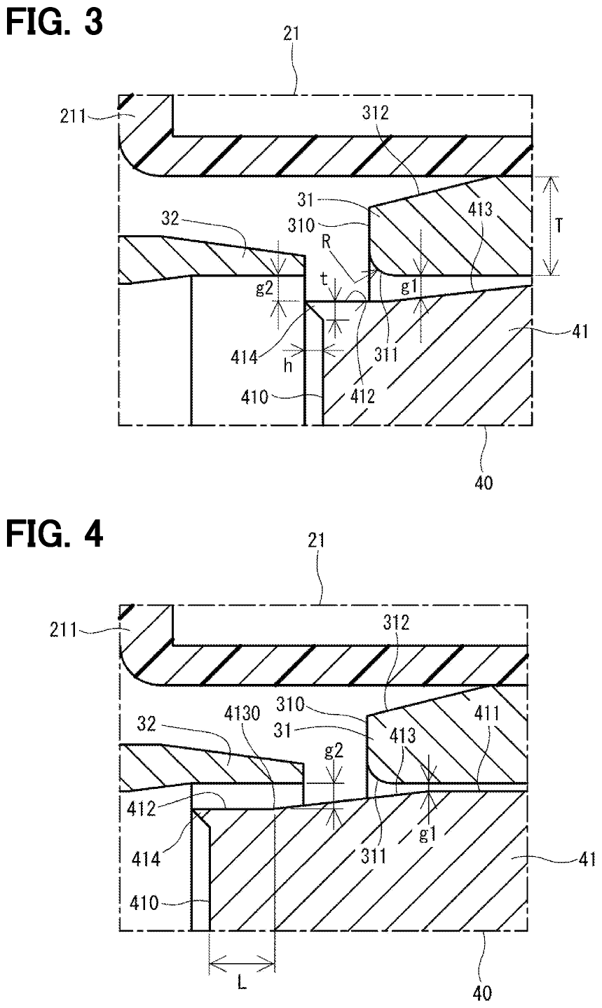

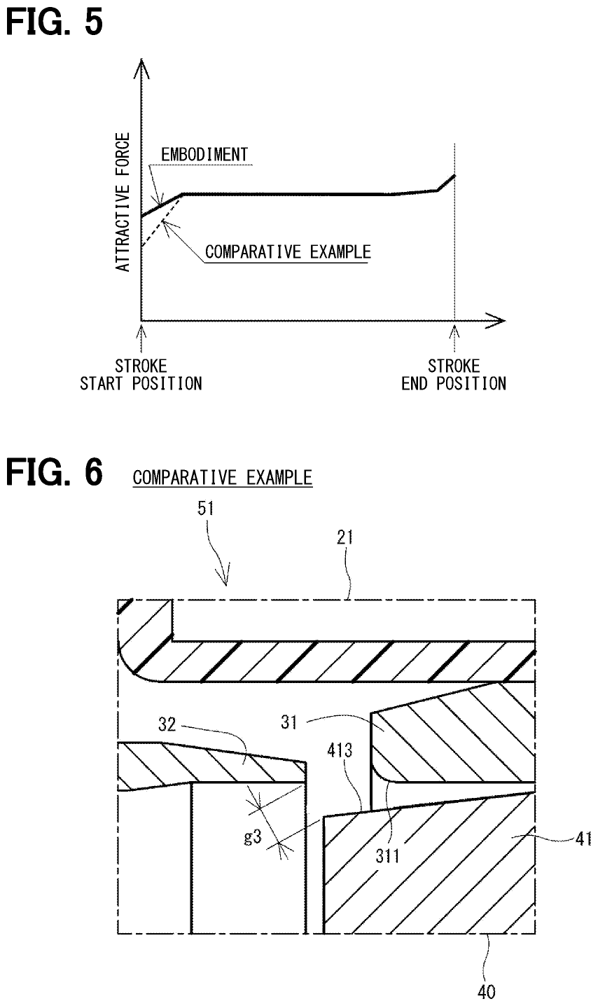

As shown in FIGS. 3 and 4, the cylinder 41 of the movable element 40 includes a large diameter cylindrical portion 411 referred to FIG. 4, a small diameter cylindrical portion 412, and a tapered portion 413. The large diameter cylindrical portion 411 is provided on one end of the cylinder 41 adjacent to the first stator 31. The small diameter cylindrical portion 412 is provided on the other end of the cylinder 41 to face the second stator 32 at the stroke end position. The tapered portion 413 is provided between the large diameter cylindrical portion 411 and the small diameter cylindrical portion 412. An outer diameter of the tapered portion 413 is increased toward the stroke start position of the movable element 40 and is decreased toward the stroke end portion of the movable element 40. Accordingly, as the movable element 40 is moved toward the stroke end position, an area of a gap (g1) between the first stator 31 and the movable element 40 in the radial direction is changed because of the tapered portion 413. Therefore, attractive force in a stroke process is equalized, as referred to FIG. 5.

The small diameter cylindrical portion 412 is a straight portion extending in the axial direction, and an outer surface of the small diameter cylindrical portion 412 has a constant diameter as shown in FIG. 3. The small diameter cylindrical portion 412 is formed continually from the tapered portion 413 toward the second stator 32. The small diameter cylindrical portion 412 has a cylindrical shape. An outer diameter of the small diameter cylindrical portion 412 is approximately same as that of a minimum diameter portion 4130 of the tapered portion 413, as shown in FIG. 4. Because of the small diameter cylindrical portion 412, an area of a gap (g2) between the movable element 40 and the second stator 32 in the radial direction is approximately constant in an area from the stroke start position to the stroke end position in the axial direction. A length (L) of the small diameter cylindrical portion 412 in the axial direction is preferably a stroke length of the movable element 40 or less. If the length of the small diameter cylindrical portion 412 is over the stroke length, control of the attractive force by the tapered portion 413 may be adversely affected.

The movable element 40 has a protrusion 414 provided on a front end surface of the cylinder 41 in the axial direction as shown in FIG. 1. A cross section of the protrusion 414 has a triangular shape. The protrusion 414 protrudes from an axial end surface 410 of the small diameter cylindrical portion 412 toward the stroke end position and is formed circularly over a whole circumference of the small diameter cylindrical portion 412. As shown in FIG. 3, a thickness (t) of the protrusion 414 in a radial direction of the cylinder 41 is preferably around a range from 0.05 mm to 1 mm. In addition, a protrusion height (h) of the protrusion 414 in the axial direction is preferably smaller than or equal to a half of the stroke length of the movable element 40.

As shown in FIGS. 1 and 2, the cover member 17 has a recess portion 172 recessed toward a direction in which the movable element 40 is moved toward the stroke end portion. The recess portion 172 is formed on an inner side corner of the cover member 17 and is opposed to the protrusion 414. The recess portion 172 is formed in an annular shape and has a depth so as to enable the protrusion 414 to enter. Therefore, when the stroke end position of the movable element 40 becomes closer to the cover member 17 than the position shown in FIG. 2, collision of the cover member 17 with the protrusion 414 can be restricted.

A curved surface 311 is formed on an inner peripheral surface of the first stator 31 at the end facing the second stator 32. As shown in FIGS. 3 and 4, the curved surface 311 extends from the inner peripheral surface of the first stator 31 toward an outer peripheral surface of the first stator 31 so as to expand the gap (g1) between the first stator 31 and the movable element 40. In addition, a slope 312 is formed on the outer peripheral surface of the first stator 31 at a side opposite to the curved surface 311. Because of the slope 312, a thickness (T) of the first stator 31 in the radial direction is reduced toward the second stator 32, as shown in FIG. 3.

In FIG. 3, a radius (R) of the curved surface 311 is preferably in a range between 0.2 mm and 90% of the thickness (T) of the first stator 31. More preferably, the radius (R) of the curved surface 311 is around a range between 0.3 mm and 3 mm.

In the electromagnetic actuator 11 structured as described above, as shown in FIG. 3, when the movable element 40 is located at the stroke start position, the tapered portion 413 is close to the second stator 32. However, the small diameter cylindrical portion 412 which has the straight line on the outer surface is formed continually from the minimum diameter portion 4130 of the tapered portion 413 toward the second stator 32 in the axial direction. Therefore, the gap (g2) between the movable element 40 and the second stator 32 in the radial direction is not enlarged when the movable element 40 is located around the stroke start position. In addition, as the protrusion 414 is formed on an end surface of the small diameter cylindrical portion 412 and protrudes toward the second stator 32, the gap (g2) is kept relatively small. Therefore, the attractive force at the initial stage of the start of the electromagnetic actuator 11 can be restricted from being decreased.

In addition, in this embodiment, the gap (g2) becomes the smallest, when the tip end of the protrusion 414 is located at the same position as a front end (edge) of the second stator 32 in the axial direction, as shown in FIG. 4. Therefore, an area of the gap (g2) is almost constant while the movable element 40 is moved from the stroke start position to the stroke end position. Additionally, as the gap (g1) is enlarged due to the curved surface 311 of the first stator 31 when the movable element 40 is located around the stroke end position, an increase in the attractive force can be restricted as the movable element 40 is located around the stroke end position. Therefore, as shown in FIG. 5, in the electromagnetic actuator 11 in the first embodiment, the constant attractive force characteristic can be secured over the entire length of the stroke.

Here, a comparative example will be described below to confirm the effect of the protrusion 414 of the movable element 40 on the attractive force characteristic. FIG. 6 shows an electromagnetic actuator 51 in the comparative example. In the electromagnetic actuator 51, the curved surface 311 is provided on the end of the first stator 31, and the tapered portion 413 is provided on the cylinder 41 of the movable element 40. However, either a small diameter cylindrical portion which has the straight line on the outer surface or a protrusion is not provided on the first stator 31 between the tapered portion 413 and the cover member 17. In this case, the attractive force is equalized by the tapered portion 413 in a stroke process. However, when the movable element 40 is located around the stroke start position, a gap (g3) between the tapered portion 413 and the second stator 32 becomes large. Therefore, in the comparative example, the attractive force at the start of the actuator is reduced as shown by a broken line in FIG. 5, and the constant attractive force characteristic cannot be secured over the entire length of the stroke.

### Second Embodiment

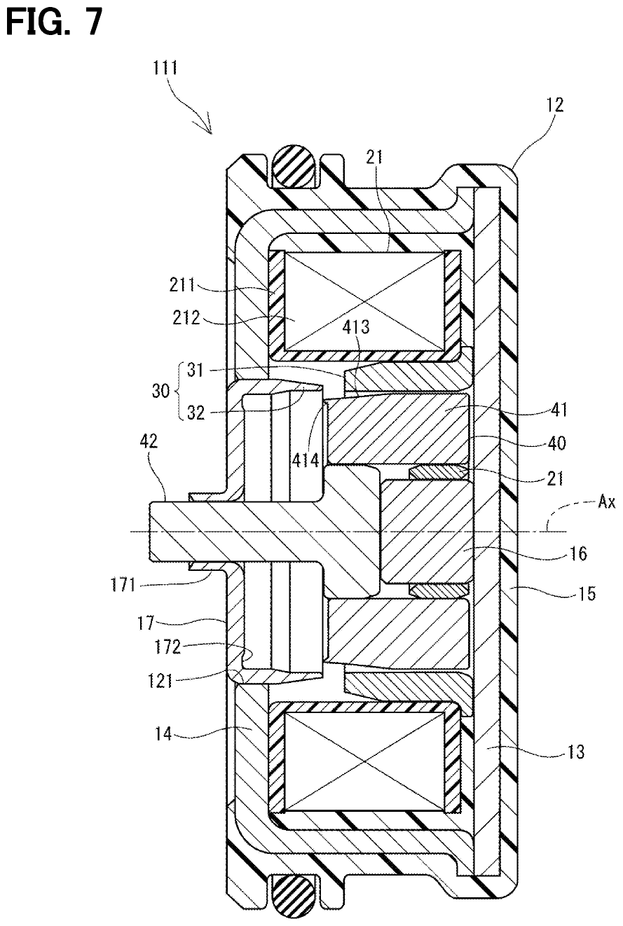

A second embodiment of the present disclosure will be described below with reference to FIG. 7. Differently from the first embodiment, an electromagnetic actuator 111 in the second embodiment does not include either a curved surface in the first stator 31 or a small diameter cylindrical portion in the cylinder 41 of the movable element 40. However, similarly to the first embodiment, in the electromagnetic actuator 111 in the second embodiment, the cylinder 41 includes the tapered portion 413. In addition, the protrusion 414 is provided on a front end of the tapered portion 413 and protrudes toward the second stator 32. Because of this, a gap between the second stator 32 and the movable element 40 is small when the movable element 40 is located around the stroke start position. Therefore, the attractive force at the start of the actuator can be restricted from being reduced, and the constant attractive force characteristic can be secured over the entire length of the stroke.

### Other Embodiments

(1) In the above embodiments, as shown in FIGS. 1 and 2, the stator 30 is arranged radially inside the coil 21, and the movable element 40 is arranged radially inside the stator 30. However, in other embodiments, the stator may be arranged radially outside the coil, the movable element may be arranged radially outside the stator, and the tapered portion and the protrusion may be provided on the movable element.

(2) In the above embodiment, the electromagnetic actuator 11 used for the valve timing adjustment mechanism is shown. However, use of the electromagnetic actuator is not limited. In other embodiments, the electromagnetic actuator of the present disclosure may be applied to various equipment or device rather than the valve timing adjustment mechanism.

(3) In addition, the present disclosure is not limited to the above embodiments and can be appropriately modified in structure or configuration of each part without departing from a spirit of the present disclosure.

What is claimed is:

1. An electromagnetic actuator comprising:
a stator; and
a movable element configured to be attracted from a stroke start position to a stroke end position in a predetermined stroke in an axial direction by magnetic force generated between the stator and the movable element when a coil is energized, wherein
the stator includes a first stator located adjacent to the movable element at the stroke start position and a second stator located closer to the movable element at the stroke end position than at the stroke start position, and
the movable element includes a tapered portion that has a diameter becoming smaller toward the second stator and a protrusion that protrudes from an end surface of the movable element close to the second stator.

2. The electromagnetic actuator according to claim 1, further comprising:
a cover member that covers a front opening of a housing, wherein
the cover member includes a recess portion recessed toward a direction in which the movable element is moved toward the stroke end position so as to allow the protrusion to enter the recess portion as the movable element is located at the stroke end position.

3. The electromagnetic actuator according to claim 1, wherein
a protrusion height of the protrusion is smaller than or equal to a half of a stroke length of the movable element.

4. The electromagnetic actuator according to claim 1, wherein
a thickness of the protrusion is in a range between 0.05 mm and 1 mm.
